(19) United States
(12) Patent Application Publication
(10) Pub. No.: US 2007/0224239 A1
(43) Pub. Date: Sep. 27, 2007

(54) Method of making a coated medical device

(76) Inventors: Niall Behan, Galway (IE); Anthony Malone, Miltown Malbay (IE); John Clarke, Claregalway (IE)

Correspondence Address: JONES DAY, 222 EAST 41ST ST, NEW YORK, NY, 10017, US

(21) Appl. No.: 11/390,801

(22) Filed: Mar. 27, 2006

(51) Int. Cl. B05D 3/00

(52) U.S. Cl. 424/423; 427/2.24

(57) ABSTRACT

The present invention relates to a method of making a coated medical device with a porous coating. The method includes coating at least a portion of the surface of a medical device with a coating composition comprising a polymer, solvent, and a gas, and then removing an amount of gas from the coating composition sufficient to form a porous coating. A biologically active material can be included in the coating composition.

### FIELD OF THE INVENTION

The invention relates generally to a method of making a coated medical device. More particularly, the invention is directed to a method of applying a coating composition to a medical device to form a porous coating, and coated medical devices made by such method.

### BACKGROUND OF THE INVENTION

There are various medical devices for long-term treatment of a patient that are designed to function as permanent implants. One example of such medical device is an implantable stent. During a surgical or invasive procedure, the medical practitioner inserts or implants a stent into a blood vessel, the urinary tract or other body lumina that are difficult to access for the purpose of, inter alia, preventing restenosis, providing vessel or lumen wall support or reinforcement and applying therapeutic treatments. Such uses of stents for long-term treatment are common. Typically, such prostheses are applied to the location of interest by using a vascular catheter, or similar transluminal device, to position the stent at the location of interest where the stent is thereafter expanded. These medical devices designed as permanent implants may become incorporated in the vascular or other tissue that they contact.

Implantation of a medical device into the body of a patient, however, can cause the body tissue to exhibit adverse physiological reactions. For instance, the insertion or implantation of certain catheters or stents can lead to the formation of emboli or clots in blood vessels or restenosis. Similarly, the implantation of urinary catheters can cause infections, particularly in the urinary tract. Other adverse reactions to medical devices include cell proliferation which can lead to hyperplasia, occlusion of blood vessels, platelet aggregation, rejection of artificial organs, and calcification.

To reduce such adverse effects as well as for other benefits, a medical device can be coated with a coating comprising a biocompatible polymer. Also, the coating can incorporate a biologically active or therapeutic material. A medical device coated with such a coating can be used for direct administration of a biologically active material into a particular part of the body when a disease is localized to the particular part, such as, without limitation, a body lumen including a blood vessel, for the treatment of the disease.

A number of various coatings for medical devices have been used. Such coatings have been applied to the surface of a medical device mostly by either spray-coating or dip-coating the device with a coating solution. The spray-coating method has been frequently used because of its excellent features, e.g., good efficiency and control over the amount or thickness of coating.

Once the medical device has been coated, it is desirable to control the release rate of the biologically active agent from the coating into the body tissue. If the biologically active agent is released or delivered into the body tissue too quickly, the effect on the patient may be greater or more sudden than desired. Conversely, if the rate of release of the biologically active agent is too slow, the agent may not have the desired effect on the patient, and the efficacy of the agent will be lost or diminished.

However, with some coating methods it is difficult to control the release rate of the biologically active agent. Also, many of the current coatings and coating methods are not capable in allowing a sufficient amount of biologically active material to elute into the body lumen.

Release of a biologically active material from a polymeric matrix is related to the available surface area of the biologically active material in contact with the release medium. Many methods have been used to increase such surface area, such as mechanical texturing of the polymer surface. However, such methods are often not efficient and cost-effective.

Thus, it is desirable to have efficient and cost-effective methods of making a coated medical device capable of releasing a desired amount of a biologically active agent from a coating disposed on a medical device.

### SUMMARY OF THE INVENTION

These and other objectives are accomplished by the present invention. The present invention provides a method of making a coated medical device, such as a coated stent. The method comprises providing a medical device having a surface and applying a coating composition to at least a portion of the surface. The coating composition comprises a solvent and a polymer and contains a gas dissolved therein. The method further comprises removing an amount of the gas from the coating composition sufficient to form a coating with a plurality of pores therein.

The coating composition can be saturated with gas. In certain embodiments, the gas may be dissolved in the coating composition by applying pressure or by decreasing the temperature.

The gas can be removed from the coating composition, by applying heat or applying a vacuum.

The steps of applying the coating composition and removing the gas from the coating composition may be repeated.

In one embodiment of the present invention, the coating composition is applied to the surface of the medical device by a spraying process. The flow rate can be about 20 mL/hour to about 40 mL/hour. During the spraying process, the gas can be introduced or dissolved into the coating composition. In another embodiment, the method further comprises atomizing the coating composition to form droplets using a pressurized gas prior to applying the coating composition to the surface. In this embodiment, the pressurized gas is the same as the gas dissolved in the coating composition.

Moreover, substantially all of the gas can be removed from the coating composition, or less than all of the gas can be removed from the coating composition so that a portion of the gas remains in the coating. In one embodiment, a portion of the gas remains in the coating and the gas is nitrous oxide.

The solvent in the coating composition can be tetrahydrofuran, chloroform, toluene, acetone, isooctane, 1,1,1-trichloroethane, or a mixture thereof. The polymer in the coating composition can be styrene-isobutylene-styrene, polyurethanes, silicones, polyesters, polyolefins, polyisobutylene, ethylene-alphaolefin copolymers, acrylic polymers and copolymers, vinyl halide polymers, polyvinyl ethers, polyvinylidene halides, polyacrylonitrile, polyvinyl ketones, polyvinyl aromatics, polyvinyl esters, copolymers of vinyl monomers, copolymers of vinyl monomers and olefins, polyamides, alkyd resins, polycarbonates, polyoxymethylenes, polyimides, polyethers, epoxy resins, polyurethanes, rayon-triacetate, cellulose, cellulose acetate, cellulose butyrate, cellulose acetate butyrate, cellophane, cellulose nitrate, cellulose propionate, cellulose ethers, carboxymethyl cellulose, collagens, chitins, polylactic acid, polyglycolic acid, polylactic acid-polyethylene oxide copolymers, EPDM rubbers, fluorosilicones, polyethylene glycol, polysaccharides, phospholipids, or a combination of the foregoing. A preferred polymer is styrene-isobutylene-styrene.

The gas introduced into the coating composition can be nitrogen, helium, carbon dioxide, argon, nitrous oxide, or a combination thereof. A preferred gas is nitrous oxide.

The coating composition of the present invention can further comprise a biologically active material. The biologically active material can be paclitaxel, a paclitaxel analogue, a paclitaxel derivative, or a combination thereof. The biologically active material can also be sirolimus, everolimus, tacrolimus, or a combination thereof.

The coating composition can further comprise a blowing agent, wherein the coating composition is heated so that the blowing agent forms the gas dissolved in the coating composition.

The present invention also provides a medical device made according to the method described above.

The present invention also provides a method of making a coated medical device that includes (a) providing a stent comprising a sidewall having a surface; and (b) applying a coating composition to at least a portion of the surface by a spraying process. The coating composition comprises a solvent, a polymer, and a biologically active material and contains a gas dissolved therein. The method further comprises removing an amount of the gas from the coating composition sufficient to form a coating with a plurality of pores therein.

In certain embodiments, the biologically active material is paclitaxel, a paclitaxel analogue, a paclitaxel derivative, or a combination thereof. In other embodiments, the biologically active material is sirolimus, everolimus, tacrolimus, or a combination thereof.

The stent preferably includes a plurality of struts forming a plurality of openings, and the surface is on the strut.

The present invention also provides a medical device made according to this method, wherein the medical device is a stent.

The method of the present invention has many advantages including providing an efficient and cost-effective manufacturing process for forming a porous coating on a medical device. The present method also provides a medical device having a porous coating from which a biologically active material can be released at a desired rate.

### BRIEF DESCRIPTION OF THE DRAWINGS

FIG. 1 shows an embodiment of a medical device made by a method of the present invention. The medical device has a surface with a coating thereon. The coating contains a biologically active material and has a plurality of pores therein.

FIG. 2 shows another embodiment of a coated medical device having a surface and a coating thereon. The coating comprises a biologically active material and pores of varying sizes. Some pores are interconnected.

FIG. 3 shows another embodiment of a medical device having a surface and a coating thereon. The coating comprises a first layer on the surface of the medical device and a second layer on the first layer. The first layer comprises a biologically active material and a plurality of pores. The second layer contains a plurality of pores.

FIG. 4 shows yet another embodiment of a medical device having a surface and a coating thereon. The coating comprises a biologically active material and a plurality of pores. The coating covers the ends of the medical device.

FIG. 5 illustrates a medical device having a surface with a porous coating thereon. The coating includes biologically active material, pores formed from gas that had been removed, and some gas bubbles trapped within the coating.

### DETAILED DESCRIPTION OF THE INVENTION

The present invention generally relates to a method for coating a medical device with a coating composition, and medical devices made by such method. The coated medical device of the present invention includes a coating having a plurality of pores therein. The coated medical device is formed by providing a medical device having a surface and applying a coating composition to at least a portion of the surface. The coating composition includes a solvent, a polymer and contains a gas dissolved therein. An amount of gas is removed from the coating to form a plurality of pores in the coating.

Medical devices suitable for the present invention include, but are not limited to, stents, surgical staples, catheters, such as balloon catheters, central venous catheters, and arterial catheters, guidewires, cannulas, cardiac pacemaker leads or lead tips, cardiac defibrillator leads or lead tips, implantable vascular access ports, blood storage bags, blood tubing, vascular or other grafts, intra-aortic balloon pumps, heart valves, cardiovascular sutures, total artificial hearts and ventricular assist pumps, and extra-corporeal devices such as blood oxygenators, blood filters, septal defect devices, hemodialysis units, hemoperfusion units, plasmapheresis units and any other medical device that can be inserted and implanted in the body of a patient.

Medical devices suitable for the present invention include those that have a tubular or cylindrical-like portion. The tubular portion of the medical device need not be completely cylindrical. For instance, the cross-section of the tubular portion can be any shape, such as rectangle, a triangle, etc., not just a circle. Such devices include, without limitation, stents, balloon catheters, and grafts. A bifurcated stent is also included among the medical devices which can be fabricated by the method of the present invention.

In addition, the tubular portion of the medical device may be a sidewall that is comprised of a plurality of struts defining a plurality of openings. The struts may be arranged in any suitable configuration. Also, the struts do not all have to have the same shape or geometric configuration. Each individual strut has a surface adapted for exposure to the body tissue of the patient. The tubular sidewall may be a stent.

Medical devices that are particularly suitable for the present invention include any kind of stent for medical purposes which is known to the skilled artisan. Suitable stents include, for example, vascular stents such as self-expanding stents and balloon expandable stents. Examples of self-expanding stents useful in the present invention are illustrated in U.S. Pat. Nos. 4,655,771 and 4,954,126 issued to Wallsten and 5,061,275 issued to Wallsten et al. Examples of appropriate balloon-expandable stents are shown in U.S. Pat. No. 5,449,373 issued to Pinchasik et al. In preferred embodiments, the stent suitable for the present invention is an Express stent. More preferably, the Express stent is an Express™ stent or an Express2™ stent.

Medical devices that are suitable for the present invention may be fabricated from metallic, ceramic, or polymeric materials, or a combination thereof. Suitable metallic materials include metals and alloys based on titanium (such as nitinol, nickel titanium alloys, thermo-memory alloy materials), stainless steel, tantalum, nickel-chrome, or certain cobalt alloys including cobalt-chromium-nickel alloys such as Elgiloy® and Phynox®. Metallic materials also include clad composite filaments, such as those disclosed in WO 94/16646.

Suitable ceramic materials include, but are not limited to, oxides, carbides, or nitrides of the transition elements such as titaniumoxides, hafnium oxides, iridiumoxides, chromium oxides, aluminum oxides, and zirconiumoxides. Silicon based materials, such as silica, may also be used.

The polymer(s) useful for forming the medical device should be ones that are biocompatible and avoid irritation to body tissue. They can be either biostable or bioabsorbable. Suitable polymeric materials include without limitation polyurethane and its copolymers, silicone and its copolymers, ethylene vinyl-acetate, polyethylene terephtalate, thermoplastic elastomers, polyvinyl chloride, polyolefins, cellulosics, polyamides, polyesters, polysulfones, polytetrafluorethylenes, polycarbonates, acrylonitrile butadiene styrene copolymers, acrylics, polylactic acid, polyglycolic acid, polycaprolactone, polylactic acid-polyethylene oxide copolymers, cellulose, collagens, and chitins.

Other polymers that are useful as materials for medical devices include without limitation dacron polyester, poly(ethylene terephthalate), polycarbonate, polymethylmethacrylate, polypropylene, polyalkylene oxalates, polyvinylchloride, polyurethanes, polysiloxanes, nylons, poly(dimethyl siloxane), polycyanoacrylates, polyphosphazenes, poly(amino acids), ethylene glycol I dimethacrylate, poly(methyl methacrylate), poly(2-hydroxyethyl methacrylate), polytetrafluoroethylene poly(HEMA), polyhydroxyalkanoates, polytetrafluorethylene, polycarbonate, poly(glycolide-lactide) co-polymer, polylactic acid, poly(γ-caprolactone), poly(γ-hydroxybutyrate), polydioxanone, poly(γ-ethyl glutamate), polyiminocarbonates, poly(ortho ester), polyanhydrides, alginate, dextran, chitin, cotton, polyglycolic acid, polyurethane, or derivatized versions thereof, i.e., polymers which have been modified to include, for example, attachment sites or cross-linking groups, e.g., RGD, in which the polymers retain their structural integrity while allowing for attachment of cells and molecules, such as proteins, nucleic acids, and the like. Preferably, for medical devices which undergo mechanical challenges, e.g., expansion and contraction, polymeric materials should be selected from elastomeric polymers such as silicones (e.g., polysiloxanes and substituted polysiloxanes), polyurethanes, thermoplastic elastomers, ethylene vinyl acetate copolymers, polyolefin elastomers, and EPDM rubbers. Because of the elastic nature of these polymers, the coating composition is capable of undergoing deformation under the yield point when the device is subjected to forces, stress or mechanical challenge.

The medical device may be pre-fabricated before application of the coatings. The pre-fabricated medical device is in its final shape. For example, if the finished medical device is a stent having an opening in its sidewall, then the opening is formed in the device before application of the coatings.

In embodiments of the present invention, the insertable or implantable portion of the medical device of the present invention has a surface. The surface may have a plurality of openings therein. Preferably, the medical device is a stent having a sidewall comprising a plurality of struts defining a plurality of openings. When the medical device is a stent comprising a plurality of struts, the surface is located on the struts.

In the present invention, a coating composition is applied to a portion of the surface of the medical device to form a coating on the surface of the medical device. Coating compositions suitable for applying to the devices of the present invention can include a polymer or a polymeric material dispersed or dissolved in a solvent suitable for the medical device, which are known to the skilled artisan.

The polymer or polymeric material used in the coating composition should be a material that is biocompatible and avoids irritation to body tissue. Preferably, the polymeric materials used in the coating composition of the present invention are selected from the following: polyurethanes, silicones (e.g., polysiloxanes and substituted polysiloxanes), and polyesters. Also preferable as a polymeric material are styrene-isobutylene-styrene copolymers. Other polymers which can be used include ones that can be dissolved and cured or polymerized on the medical device or polymers having relatively low melting points that can be blended with biologically active materials. Additional suitable polymers include, thermoplastic elastomers in general, polyolefins, polyisobutylene, ethylene-alphaolefin copolymers, acrylic polymers and copolymers, vinyl halide polymers and copolymers such as polyvinyl chloride, polyvinyl ethers such as polyvinyl methyl ether, polyvinylidene halides such as polyvinylidene fluoride and polyvinylidene chloride, polyacrylonitrile, polyvinyl ketones, polyvinyl aromatics such as polystyrene, polyvinyl esters such as polyvinyl acetate, copolymers of vinyl monomers, copolymers of vinyl monomers and olefins such as ethylene-methyl methacrylate copolymers, acrylonitrile-styrene copolymers, ABS (acrylonitrile-butadiene-styrene) resins, ethylene-vinyl acetate copolymers, polyamides such as Nylon 66 and polycaprolactone, alkyd resins, polycarbonates, polyoxymethylenes, polyimides, polyethers, epoxy resins, rayon-triacetate, cellulose, cellulose acetate, cellulose butyrate, cellulose acetate butyrate, cellophane, cellulose nitrate, cellulose propionate, cellulose ethers, carboxymethyl cellulose, collagens, chitins, polylactic acid, polyglycolic acid, polylactic acid-polyethylene oxide copolymers, EPDM (ethylene-propylene-diene) rubbers, fluorosilicones, polyethylene glycol, polysaccharides, phospholipids, and combinations of the foregoing.

More preferably for medical devices which undergo mechanical challenges, e.g., expansion and contraction, the polymeric materials should be selected from elastomeric polymers such as silicones (e.g. polysiloxanes and substituted polysiloxanes), polyurethanes, thermoplastic elastomers, ethylene vinyl acetate copolymers, polyolefin elastomers, and EPDM rubbers. Because of the elastic nature of these polymers, the coating composition is capable of undergoing deformation under the yield point when the device is subjected to forces, stress or mechanical challenge.

One or more solvents may be used with each coating composition. The solvents used to prepare coating compositions include ones which can dissolve the polymeric material into solution or suspend the polymeric material. If a biologically active material is present in the coating compositions, the solvent preferably can also dissolve or suspend the biologically active material. Any solvent which does not alter or adversely impact the therapeutic properties of the biologically active material can be employed in the method of the present invention.

Examples of suitable solvents include, but are not limited to, tetrahydrofuran (THF), methylethylketone, chloroform, toluene, acetone, isooctane, 1,1,1,-trichloroethane, dichloromethane, isopropanol, IPA, and mixture thereof. Preferred solvents include toluene and THF.

The coating composition may also contain one or more biological active materials. The term “biologically active material” encompasses therapeutic agents, such as biologically active agents, and also genetic materials and biological materials. The genetic materials mean DNA or RNA, including, without limitation, of DNA/RNA encoding a useful protein stated below, intended to be inserted into a human body including viral vectors and non-viral vectors as well as anti-sense nucleic acid molecules such as DNA, RNA and RNAi.

Viral vectors include adenoviruses, gutted adenoviruses, adeno-associated virus, retroviruses, alpha virus (Semliki Forest, Sindbis, etc.), lentiviruses, herpes simplex virus, ex vivo modified cells (e.g., stem cells, fibroblasts, myoblasts, satellite cells, pericytes, cardiomyocytes, skeletal myocytes, macrophage), replication competent viruses (e.g., ONYX-015), and hybrid vectors. Non-viral vectors include artificial chromosomes and mini-chromosomes, plasmid DNA vectors (e.g., pCOR), cationic polymers (e.g., polyethyleneimine, polyethyleneimine (PEI)) graft copolymers (e.g., polyether-PEI and polyethylene oxide-PEI), neutral polymers PVP, SP1017 (SUPRATEK), lipids or lipoplexes, nanoparticles and microparticles with and without targeting sequences such as the protein transduction domain (PTD). The biological materials include cells, yeasts, bacteria, proteins, peptides, cytokines and hormones. Examples for peptides and proteins include growth factors (FGF, FGF-1, FGF-2, VEGF, Endotherial Mitogenic Growth Factors, and epidermal growth factors, transforming growth factor and platelet derived endothelial growth factor, platelet derived growth factor, tumor necrosis factor, hepatocyte growth factor and insulin like growth factor), transcription factors, proteinkinases, CD inhibitors, thymidine kinase, and bone morphogenic proteins (BMP's), such as BMP-2, BMP-3, BMP-4, BMP-5, BMP-6 (Vgr-1), BMP-7 (OP-1), BMP-8, BMP-9, BMP-10, BMP-11, BMP-12, BMP-13, BMP-14, BMP-15, and BMP-16. Currently preferred BMP's are BMP-2, BMP-3, BMP-4, BMP-5, BMP-6, BMP-7. These dimeric proteins can be provided as homodimers, heterodimers, or combinations thereof, alone or together with other molecules. Cells can be of human origin (autologous or allogeneic) or from an animal source (xenogeneic), genetically engineered, if desired, to deliver proteins of interest at the transplant site. The delivery media can be formulated as needed to maintain cell function and viability. Cells include whole bone marrow, bone marrow derived mono-nuclear cells, progenitor cells (e.g., endothelial progentitor cells) stem cells (e.g., mesenchymal, hematopoietic, neuronal), pluripotent stem cells, fibroblasts, macrophage, and satellite cells. Biologically active material also includes non-genetic therapeutic agents, such as:
anti-thrombogenic agents such as heparin, heparin derivatives, urokinase, and PPack (dextrophenylalanine proline arginine chloromethylketone);
anti-proliferative agents such as enoxaprin, angiopeptin, geldanamycin, or monoclonal antibodies capable of blocking smooth muscle cell proliferation, hirudin, acetylsalicylic acid, tanolimus, everolimus, amlodipine and doxazosin;
anti-inflammatory agents such as glucocorticoids, betamethasone, dexamethasone, prednisolone, corticosterone, budesonide, estrogen, sulfasalazine, rosiglitazone, mycophenolic acid, and mesalamine;
antineoplastic/antiproliferative/anti-miotic agents such as paclitaxel, 5-fluorouracil, cisplatin, vinblastine, vincristine, epothilones, epithilone D, methotrexate, azathioprine, adriamycin and mutamycin; endostatin, angiostatin and thymidine kinase inhibitors, cladribine, taxol and its analogs or derivatives;
anesthetic agents such as lidocaine, bupivacaine, and ropivacaine;
anti-coagulants such as D-Phe-Pro-Arg chloromethyl keton, an RGD peptide-containing compound, heparin, antithrombin compounds, platelet receptor antagonists, anti-thrombin antibodies, anti-platelet receptor antibodies, aspirin (aspirin is also classified as an analgesic, antipyretic and anti-inflammatory drug), dipyridamole, protamine, hirudin, prostaglandin inhibitors, antiplatelet agents such as trapidil or liprostin, platelet inhibitors and tick antiplatelet peptides;
vascular cell growth promotors such as growth factors, Vascular Endothelial Growth Factors (FEGF, all types including VEGF-2), growth factor receptors, transcriptional activators, and translational promotors;
DNA demethylating drug such as 5-azacytidine, which is also categorized as a RNA or DNA metabolite that inhibit cell growth and induce apoptosis in certain cancer cells;
vascular cell growth inhibitors such as antiproliferative agents, growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and a cytotoxin;
cholesterol-lowering agents; vasodilating agents; and agents which interfere with endogenous vasoactive mechanisms;
anti-oxidants, such as probucol;
antibiotic agents, such as penicillin, cefoxitin, oxacillin, tobranycin, rapamycin (sirolimus);
antagonist for collagen synthesis, such as halofuginone;
angiogenic substances, such as acidic and basic fibrobrast growth factors, estrogen including estradiol (E2), estriol (E3) and 17-Beta Estradiol;
anti-platelet aggregation substance, phosphodiesterase inhibitors, such as cilostazole;
smooth muscle cell proliferation inhibitors, such as rapamycin; and
drugs for heart failure, such as digoxin, beta-blockers, angiotensin-converting enzyme (ACE) inhibitors including captopril and enalopril, statins and related compounds.

Preferred biologically active materials include anti-proliferative drugs such as steroids, vitamins, and restenosis-inhibiting agents. Preferred restenosis-inhibiting agents include microtubule stabilizing agents such as paclitaxel, paclitaxel analogues, derivatives, and mixtures thereof. For example, derivatives suitable for use in the present invention include 2′-succinyl-taxol, 2′-succinyl-taxol triethanolamine, 2′-glutaryl-taxol, 2′-glutaryl-taxol triethanolamine salt, 2′-O-ester with N-(dimethylaminoethyl) glutamine, and 2′-O-ester with N-(dimethylaminoethyl) glutamide hydrochloride salt.

Other preferred biologically active materials include nitroglycerin, nitrous oxides, nitric oxides, antibiotics, aspirins, digitalis, estrogen derivatives such as estradiol and glycosides.

The amount of biologically active material present in the coating composition can be adjusted to meet the needs of the patient. In general, the amount of the biologically active material used may vary depending on the application or biologically active material selected. In addition, the quantity of biologically active material used may be related to the selection of the polymer. One of skill in the art would understand how to adjust the amount of a particular biologically active material to achieve the desired dosage or amount.

The polymeric material and biologically active material should be dissolved or suspended in a solvent to form a coating composition. Any suitable combination of materials may be used for the coating composition. For example, the composition may include about 90% toluene, about 5% tetrahydrofurane, and less than about 5% of the polymer and biologically active material. Preferably, the amount of the solvent is about 90% to about 99%, and more preferably about 95% to about 99%.

The coating composition also contains a gas dissolved therein. Any gas or combination of gases could be used in the present invention. Suitable gases include, but are not limited to, nitrogen, helium, carbon dioxide, oxygen, argon and nitrous oxide, or a combination thereof.

The dissolved gas is generally in the form of bubbles in the coating composition. The gas can be introduced into the coating composition by any suitable method. For example, one method is to bubble the gas into the coating composition or maintain a flow of gas over the coating composition under reduced temperature or elevated pressure or a combination thereof. The gas may be aerosolized and used with a spraying apparatus.

Experimental conditions can be manipulated to control the amount of gas that is dissolved in the solution as known to one skilled in the art. The gas may be partially or completely dissolved into the solution. Furthermore, the coating composition may be saturated with the dissolved gas. The solubility of the gas in the coating composition can be adjusted as known to one skilled in the art. For example, the temperature and/or pressure can be adjusted to affect the solubility of the gas in the coating composition.

The gas may be introduced before or during application of the coating composition to the medical device. Preferably, the gas is dissolved in the coating composition during the application process.

In certain embodiments, the coating composition includes an additive such as a blowing agent. A blowing agent is a solid that decomposes into a gas upon heating. Preferably, the blowing agent is biocompatible. Suitable blowing agents include, but are not limited to, 1,1-azobisformamide, 1,1,1,3,3-pentafluoropropane, azodicarbonamide and benzosulfonohydrazide. The blowing agent is incorporated into the coating composition as a solid or solute in a solution. After the coating composition comprising the blowing agent is applied to a surface of the medical device, the coating composition is heated so that the blowing agent forms the gas in the coating composition. The coating composition may be heated to any suitable temperature. Preferably, the coating composition is a heated to a temperature less than the decomposition temperature of the polymer or the biologically active material present in the coating composition. For example, the coating composition can generally be heat to about 600 to about 70° or higher depending on the materials in the coating composition.

The coating composition which contains the gas dissolved therein is applied to at least a portion of a surface of a medical device. The coating composition may be applied to any desired portion of the medical device. For example, the coating composition may be applied to the inner or outer surface or side surfaces of a sidewall of a medical device. The coating composition may also be applied to one or both ends of a sidewall of a medical device such as a stent, or the coating composition may be applied to the middle of the surface of the sidewall.

The coating composition can be applied by any suitable method to a surface of a medical device to form a coating. Examples of suitable methods include, but are not limited to, spraying such as by conventional nozzle or ultrasonic nozzle, dipping, rolling, and electrostatic deposition or spraying, and a batch process such as air suspension, pancoating or ultrasonic mist spraying. More than one of these coating methods can be used to form the coating. A preferred method is a spraying process. Any spray technology may be used. For example, one suitable spraying process includes forcing the coating composition through a small orifice and atomizing the coating composition at the output by applying a compressed gas such as nitrogen. In using the above methods to atomize the coating composition, the parameters may be adjusted to manipulate the droplet size and rate at which the droplets are deposited.

An application method, like spraying, that uses pressurized gas to apply the coating composition may use the same or a different type of gas that is contained in the coating composition. Preferably, the same gas is used. By using the same gas, the number of processing steps required to form the coating is reduced. Thus, the porous coating can be formed more efficiently.

An expandable stent may be sprayed in either an expanded or unexpanded position. Preferably, a stent is sprayed in the unexpanded position.

The coating composition may be sprayed at any suitable flow rate, which can be selected by one skilled in the art. Primarily, flow rate is determined by the coat weight and thickness required by the particular medical device being coated. Preferably, the coating composition is sprayed at a flow rate of about 20 mL/hour to about 40 mL/hour. A preferred flow rate is about 25 mL/hour.

Other spray parameters may be adjusted as known to one skilled in the art. The coating composition may be sprayed in any pattern, such as in a cone pattern. In addition, the coating composition may be sprayed from any suitable device such as, but not limited to, a nozzle apparatus. The medical device may move across a nozzle apparatus as it sprays the coating composition, or the nozzle apparatus may traverse the medical device as it sprays the coating composition on the surface of the medical device.

The coating composition may be applied in one or more passes to form one or more coating layers. When a plurality of layers are applied, each layer could be comprised of the same or different coating compositions. More than one coating composition may also be applied to the medical device. For example, a first coating composition may include a polymer, a biologically active material, and a solvent and the second coating composition may include a polymer and a solvent. The second coating composition may be applied to the first coating composition and/or on a surface of the medical device. One or more of the coating compositions may include a gas dissolved therein.

During application of the coating composition or after the coating composition has been applied or deposited on the surface of the medical device, at least a portion of the gas in the coating composition is removed to form a plurality of pores in the coating. The gas may be removed by any suitable method. For example, gas may be removed by evaporation or by application of a vacuum to the coating composition. The gas may also be removed by applying heat or pressure.

In another embodiment, not all of the gas is removed so that a portion of the gas remains within the coating. It may be desired to have certain gases or combination of gases having therapeutic properties remain within the coating. One example of such a gas is nitrous oxide.

The number and size of the pores in the coating can be varied by adjusting the amount of gas introduced into the coating composition and then removed from the coating. In particular, a greater amount of gas in the coating composition will result in a more porous coating. In addition, the rate at which the gas is removed from the coating composition can affect the pore size. For example, fast removal of the gas can create small pores, whereas slow removal can create larger pores.

The process described above may be repeated to form coatings of different thicknesses or containing multiple coating layers. When more than one coating composition is applied, the gas can be removed after application of each coating composition containing a gas or after all the coating compositions containing a gas have been deposited on the medical device.

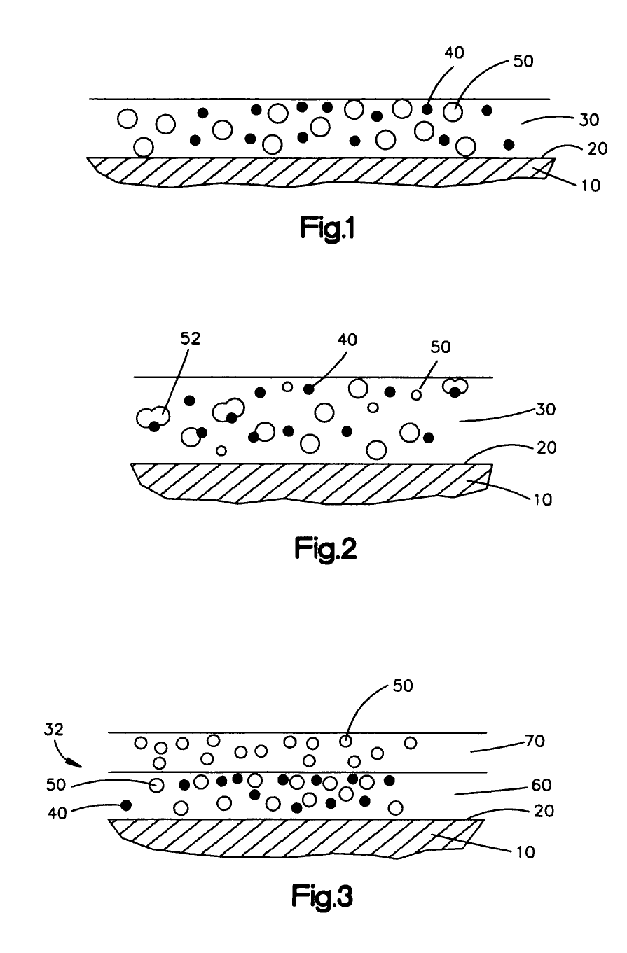

FIGS. 1-5 show various embodiments of medical devices made by the method of the present invention. FIG. 1 illustrates a medical device 10 that has a surface 20 with a coating 30 thereon. The coating 30 contains a biologically active material 40 and a plurality of pores 50 therein. FIG. 2 shows another embodiment of a coated medical device 10 having a surface 20 with a coating 30 thereon. The coating 30 comprises a biologically active material 40 and a plurality of pores 50 therein. The pores 50 are of varying sizes and some pores 50 are interconnected pores 52.

FIG. 3 shows an embodiment in which the coating 32 comprises a first layer 60 disposed on the surface 20 of the medical device 10 and a second layer 70 disposed on the first layer 60. The first layer 60 comprises a biologically active material 40 and a plurality of pores 50, therein. The second layer 70 contains a plurality of pores 50.

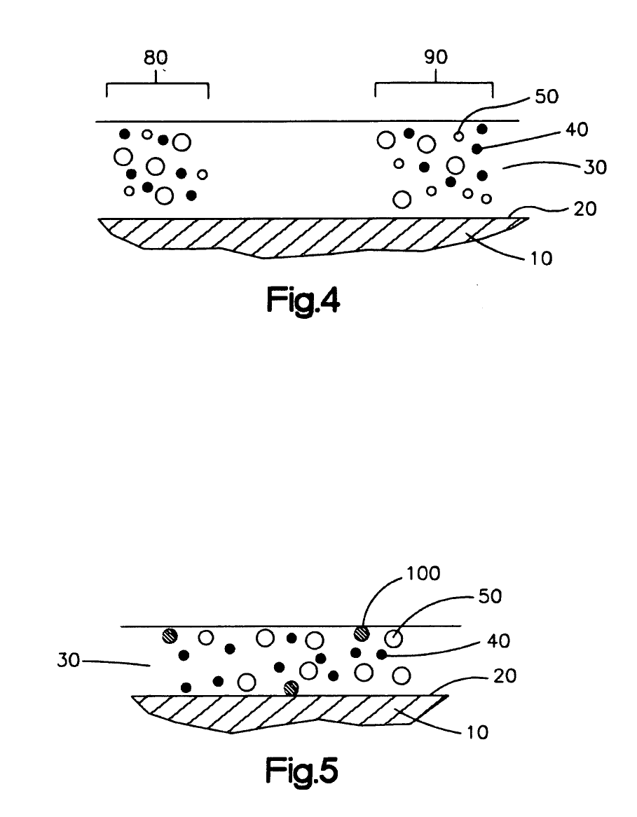

FIG. 4 shows a medical device 10 having a surface 20, a first end 80 and a second end 90 wherein a coating 30 comprising a biologically active material 40 and a plurality of pores 50 is applied to the first end 80 and the second end 90. Therefore, the end portions 80, 90 of the surface 20 of the medical device 10 are covered with the coating 30 while the middle portion of the surface 20 is free of the coating 30.

FIG. 5 illustrates a medical device 10 having a surface 20 with a coating 30 thereon. The coating 30 includes biologically active material 40 and a plurality of pores 50 formed from a portion of gas that had been removed. Some gas 100 remains within the coating 30 as gas bubbles.

As shown in the figures, a single layer or a plurality of layers can be applied to a medical device surface to form the coating on the surface of the medical device. Thus, the present method can be used to create one homogeneous layer, or a plurality of layers comprised of different materials.

The coating layers may also contain different porosities. For example, one layer may be more porous than another layer. In addition, each coating layer may have different amounts of pores or have pores of different sizes. For example, a layer may contain a greater number of pores and/or larger pores than another layer. A single layer may also have pores of various sizes as shown in FIG. 2.

One or more coating layers may include pores. The coating layers may also contain different polymers, or each coating layer may contain the same combination of polymers, but contain different amounts of each polymer. For example, a first coating layer and a second or additional coating layer may contain different materials that release certain biologically active materials at different rates. If the coating is composed of a plurality of layers, each layer may contain a single biologically active material or a combination of biologically active materials, or not contain a biologically active material.

Also, the coating layers may be of different thicknesses and be arranged in any configuration on the medical device, such as disposed on different areas of the medical device or the first coating layer may cover the surface of the medical device and the second coating layer may be disposed on the first coating layer. For example, the coating layers may be adjacent on the surface of the medical device. Two coating layers can be applied to different portions of the surface of a medical device.

Alternatively, a first coating layer may be disposed on the surface of the medical device and a second or additional coating layer may be disposed over at least a portion of the first coating layer. The second coating layer may or may not also be disposed on the surface of the medical device. The layers may be disposed on different portions of the surface of the medical device as shown in FIG. 4.

Any other desired configuration and composition of the coating may be formed using the methods of the present invention.

In use, a coated medical device, such as an expandable stent, of the present invention may be used for any appropriate medical procedure. The coating medical device is inserted into a body lumen where it is positioned to a target location. Delivery of the medical device to a body lumen of a patient can be accomplished using methods well known to those skilled in the art, such as mounting the stent on an inflatable balloon disposed at the distal end of a delivery catheter. The biologically active material diffuses through the coating to the body lumen. This enables administration of the biologically active material to be site specific, limiting the exposure of the rest of the body to the biologically active material.

The description contained herein is for purposes of illustration and not for purposes of limitation. Changes and modifications may be made to the embodiments of the description and still be within the scope of the invention. Furthermore, obvious changes, modifications or variations will occur to those skilled in the art. Also, all references cited above are incorporated herein by reference, in their entirety, for all purposes related to this disclosure.

We claim:

1. A method of making a coated medical device comprising:
(a) providing a medical device having a surface;
(b) applying a coating composition to at least a portion of the surface wherein the coating composition comprises a solvent and a polymer and contains a gas dissolved therein; and
(c) removing an amount of the gas from the coating composition to form a coating with a plurality of pores therein.

2. The method of claim 1, wherein the coating composition is saturated with the gas.

3. The method of claim 1, wherein the gas is dissolved in the coating composition by applying pressure.

4. The method of claim 1, wherein the gas is dissolved in the coating composition by decreasing the temperature.

5. The method of claim 1, wherein the gas is removed from the coating composition by applying heat.

6. The method of claim 1, wherein the gas is removed from the coating composition by applying a vacuum.

7. The method of claim 1, further comprising repeating steps (b) and (c).

8. The method of claim 1, wherein the coating composition is applied by a spraying process.

9. The method of claim 8, wherein the flow rate is about 20 nm hour to about 40 mL/hour.

10. The method of claim 8, wherein the gas is dissolved in the coating composition during the spraying process.

11. The method of claim 1, further comprising atomizing the coating composition to form droplets using a pressurized gas prior to applying the coating composition to the surface.

12. The method of claim 11, wherein the pressurized gas is the same as the gas dissolved in the coating composition.

13. The method of claim 1, wherein substantially all of the gas is removed from the coating composition.

14. The method of claim 1, wherein less than all of the gas is removed from the coating composition so that a portion of the gas remains in the coating.

15. The method of claim 14, wherein the gas is nitrous oxide.

16. The method of claim 1, wherein the medical device is a stent.

17. The method of claim 1, wherein the solvent is tetrahydrofuran, chloroform, toluene, acetone, isooctane, 1,1,1-trichloroethane, or a mixture thereof.

18. The method of claim 1, wherein the polymer is styrene-isobutylene-styrene, polyurethanes, silicones, polyesters, polyolefins, polyisobutylene, ethylene-alphaolefin copolymers, acrylic polymers and copolymers, vinyl halide polymers, polyvinyl ethers, polyvinylidene halides, polyacrylonitrile, polyvinyl ketones, polyvinyl aromatics, polyvinyl esters, copolymers of vinyl monomers, copolymers of vinyl monomers and olefins, polyamides, alkyd resins, polycarbonates, polyoxymethylenes, polyimides, polyethers, epoxy resins, polyurethanes, rayon-triacetate, cellulose, cellulose acetate, cellulose butyrate, cellulose acetate butyrate, cellophane, cellulose nitrate, cellulose propionate, cellulose ethers, carboxymethyl cellulose, collagens, chitins, polylactic acid, polyglycolic acid, polylactic acid-polyethylene oxide copolymers, EPDM rubbers, fluorosilicones, polyethylene glycol, polysaccharides, phospholipids, or a combination of the foregoing.

19. The method of claim 18, wherein the polymer is styrene-isobutylene-styrene.

20. The method of claim 1, wherein the gas is nitrogen, helium, carbon dioxide, argon, nitrous oxide, or a combination thereof.

21. The method of claim 20, wherein the gas is nitrous oxide.

22. The method of claim 1, wherein the coating composition further comprises a biologically active material.

23. The method of claim 22, wherein the biologically active material is paclitaxel, a paclitaxel analogue, a paclitaxel derivative, or a combination thereof.

24. The method of claim 22, wherein the biologically active material is sirolimus, everolimus, tacrolimus, or a combination thereof.

25. The method of claim 1, wherein the coating composition further comprises a blowing agent, and wherein the coating composition is heated so that the blowing agent forms the gas dissolved in the coating composition.

26. A medical device made according to the method of claim 1.

27. A method of making a coated medical device comprising:
(a) providing a stent comprising a sidewall having a surface;
(b) applying a coating composition to at least a portion of the surface by a spraying process, wherein the coating composition comprises a solvent, a polymer, and a biologically active material, and contains a gas dissolved therein; and
(c) removing an amount of the gas from the coating composition to form a coating with a plurality of pores therein.

28. The method of claim 27, wherein the biologically active material is paclitaxel, a paclitaxel analogue, a paclitaxel derivative, or a combination thereof.

29. The method of claim 27, wherein the biologically active material is sirolimus, everolimus, tacrolimus, or a combination thereof.

30. The method of claim 27, wherein the sidewall comprises a plurality of struts forming a plurality of openings, and the surface is on the strut.

31. A medical device made according to the method of claim 27.
